(19) United States
(12) Patent Application Publication
(10) Pub. No.: US 2015/0121730 A1
(43) Pub. Date: May 7, 2015

(54) LUGGAGE STRAP AND COLLECTIBLE SLEEVE SYSTEM FOR CUSTOMIZATION AND RAPID IDENTIFICATION OF PERSONAL CARRY ITEMS

(71) Applicant: Valerie Freer, Aptos, CA (US)

(72) Inventor: Valerie Freer, Aptos, CA (US)

(21) Appl. No.: 14/488,080

(22) Filed: Sep. 16, 2014

Related U.S. Application Data
(60) Provisional application No. 61/878,479, filed on Sep. 16, 2013.

(51) Int. Cl. A45C 13/42; G09F 3/14; G09F 3/18

(52) U.S. Cl. CPC A45C 13/42; G09F 3/18; G09F 3/14
USPC 40/6; 40/642.02

(57) ABSTRACT

The present invention relates to a more convenient and fun way to customize luggage in such a way that it can provide a rapid identification to the owner and that the luggage or personal item, even when viewed from a distance, is unmistakably theirs. The present disclosure provides information regarding a collectible sleeve system which increases the ability of users to more accurately identify and/or account for their personal items when traveling.

### CROSS REFERENCE TO RELATED PATENT APPLICATIONS

Embodiments of the present invention relate to U.S. Provisional Application Ser. No. 61/878,479 filed Sep. 16, 2013, entitled “LUGGAGE STRAP AND COLLECTIBLE SLEEVE SYSTEM FOR CUSTOMIZATION AND RAPID IDENTIFICATION OF PERSONAL CARRY ITEMS”, the contents of which are incorporated by reference herein and which is a basis for a claim of priority.

### BACKGROUND OF THE INVENTION

1. Field of the Invention

This description relates generally to identification and individualization of items including but not limited to luggage belts, backpacks, camera straps, and laptop bag straps, and more specifically to a customizable collection and implementation system for more rapidly and accurately identifying and accounting for one's personal carry items such as luggage, electronics, equipment or tools, sports or music gear, and handbags.

2. Background Information

Identifying ones luggage or other articles can often be difficult. According to the US Census records, there are over 245 million adults in the United States. According to the US Travel Association, of those adults, 48% will make a business trip and 42% will make a leisure trip by air during 2012. Approximately 9.3 million Americans will take a cruise during 2012. These two modes of travel present the common problem of finding ones luggage at points of transmission during the trip.

Many suitcases look alike and are often of the same color, with black being the most common. This is typically not a problem when traveling alone or with ones bags stored in an overhead bin. However, when taking advantage of mass transportation, such as airline flights where bags are checked and later delivered to a carousel with everyone else's bags, identification can be a problem. People often see a bag they think is theirs, and rush up to the carousel to find that on closer look it is not theirs. Sometimes bags are retrieved and examined and then returned to the carousel after a numbered tag is read. Sometimes, the wrong bag goes home with the wrong person. Passengers oftentimes attach large name tags, a piece of fabric, or colored string to their bags so that owners can identify and retrieve them easier. Most commonly travelers use tasteful luggage tags many of which are supplied by the manufacturer of the luggage. Accordingly, manufacturers try to provide a distinctive identification tag on all luggage items in their lines. Most travelers understand that the luggage itself cannot readily be distinguished from similar luggage from another manufacture, and that many other travelers will have the exact same make and model bag as their own. Thus, in most instances, the only way that a particular luggage item can be identified is by looking at a personal identification card inserted in the identification tag, which often cannot be viewed until the luggage item is so close as to make it difficult to both identify the item and retrieve it from the carousel before it moves out of reach.

Additionally, the total number of bags an individual or a group may have is often forgotten by traveller's or operators and subsequently some luggage is often accidentally left behind on the luggage carousel, cart, hotel or bus.

Thus, there exists a genuine need for a more convenient and fun way to customize luggage in such a way that it can provide a rapid identification to the owner that the luggage or personal item even when viewed from a distance is unmistakably theirs. The present invention satisfies this need by providing a collectible sleeve system increases the ability for users to more accurately identify and/or account for their personal items when traveling.

### SUMMARY OF THE INVENTION

The present example provides a luggage identification system that may be individualized by the passenger to uniquely identify their luggage or other personal items.

The present invention contemplates a device, method and system for a sleeve to slide over a luggage belt or other strap in order to individualize the same. This system enables a wide variety of combinations to provide the owner of luggage an easy and quick instant identification from a distance tags as well as providing a way to display vacation destinations, causes, hobbies, sports, teams, colleges, businesses, events, etc. Although intended primarily as a system for luggage in a travel setting, the usefulness of the invention extends to any situation in which the owner of a case, bag, or similar article might want an easy visual means of identification or individualization to confirm ownership or as for display purposes as mentioned above. This invention is functional and fun.

This invention can augment or replace existing ID tags, as it provides a means of instantly recognizing one's luggage from a distance by the combination of sleeves on the luggage belt. Confidential information included in ID tags could then be inserted in closed ID tags leading to better security for the traveler.

Advantages of the present invention and key characteristics include:

A multitude of sleeve designs provide limitless combinations with which luggage owners can create their own individual and personalized identifiers;

Increased safety to the traveler in that their confidential/private information does not need to be in plain sight.

Simple-to-manufacture and cost-effective design;

Easy to use.

### BRIEF DESCRIPTION OF THE DRAWINGS

FIG. 1 is a depiction of an embodied luggage identification system wherein the sleeves are attached to a luggage belt and the system is coupled to a suitcase.

FIG. 2 is a diagram showing a back plan view of an embodied sleeve.

FIG. 3 is a diagram showing a side plan view of the embodied sleeve of FIG. 2 as it would be stretched to slide over the luggage belt or other strapping.

FIG. 4 is a diagram showing a front view of five sample sleeves.

FIG. 5 is a diagram showing a luggage belt with the five sample sleeves of FIG. 4 on it.

### DETAILED DESCRIPTION OF THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a luggage identification system. Although the present examples are described and illustrated herein as being implemented in a baggage retrieval system, the system described is provided as an example and not a limitation. The present examples are suitable for application in a variety of different types of identification systems, such as the identification and pairing of owners to belongings, people to a group, people to a location, etc.

In the case of a typical luggage carousel the belt can have a speed of approximately 90 feet per minute. With this rate of travel it may be useful to provide a luggage identification that may be identifiable from over 22 feet away so that the bag may be identified from this distance, and its owner can get to it and claim it before it passes beyond reach. The fact that the sleeves slide onto the luggage belt mean that all four sides of the bag can be used to individualize that piece of luggage to a person as opposed to one tag at one end of the luggage.

The present example provides a luggage identification system that may be personalized by the traveler to uniquely identify their luggage. The luggage identification system may include a luggage belt together with a various number of various sleeves. The sleeves are manufactured from an elastic material with stitching or patch applique on the front side of each in order that travelers can individualize their luggage for identification as well as to display things important to them such as past travel destinations or being a fan of a certain team, college, hobby, or cause for example. And, should the traveler wish to alter the unique combination, the sleeves are easily removed, exchangeable, and re-useable. The luggage identification system is also of sufficient strength and shape to keep the luggage securely closed in the event the zipper or other closure should fail and act as a handle for retrieving the luggage, which tends to be useful as the passenger may naturally tend to reach for what they recognize.

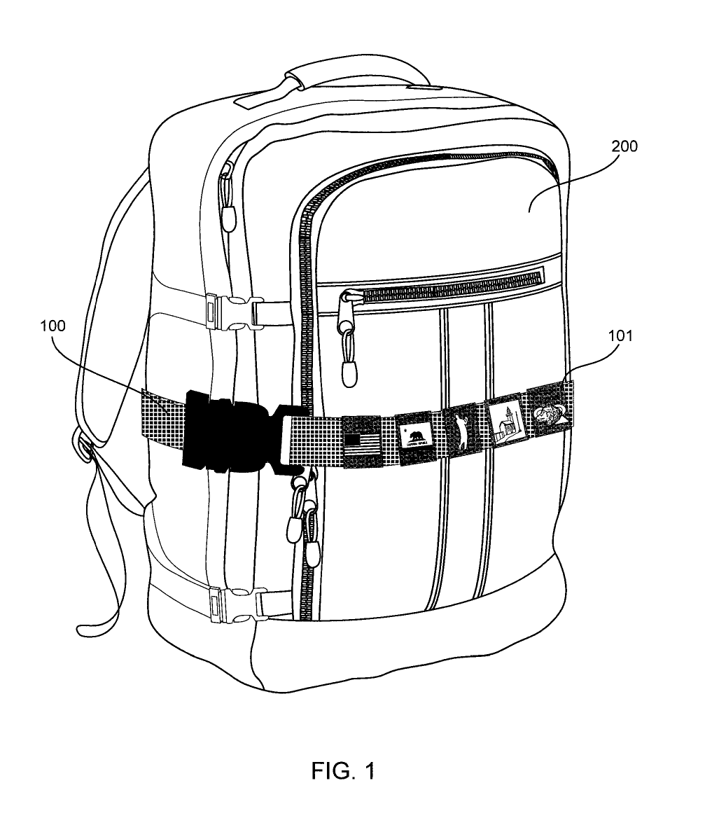

An exemplary embodied luggage belt device is shown in FIG. 1, which is a depiction of a luggage identification system 100 coupled to a suitcase 200. As shown, an example of the luggage identification system 100 can be strapped around a suitcase 200. The suitcase 200 is exemplary only and the luggage identification system 100 may couple to other equivalent structures. As can be seen in the diagram, the luggage identification system 100 makes the suitcase 200 easily identifiable. The suitcase 200 is typical of the many types of bags that may be present on a baggage carousel. They typically appear to be similar in size, shape and color—common characteristics that do not lend to the easy identification of one's particular suitcase while they are in motion on a baggage carousel. However the luggage identification system 100 tends to promote visibility and identification of one's luggage. In addition, one or more luggage identification systems may be affixed to the bag to further individualize a traveler's luggage.

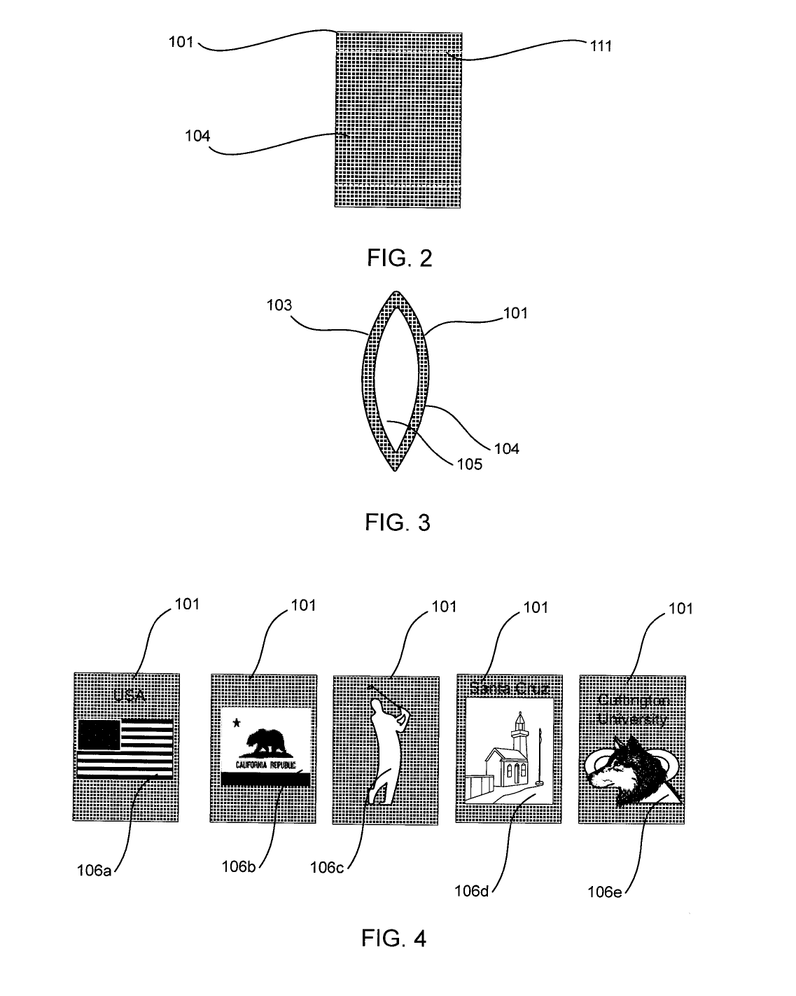

An exemplary embodied sleeve device 101 is shown in FIGS. 2 and 3. FIG. 2 is a diagram showing the back 104 of the sleeve 101. The sleeve 101 may be made from an elasticized fabric sewed into a flattened tube. Although the size can vary, a preferred size is approximately 2 inches in width and 2.25 inches in height. Preferred stitching would close at the top and the bottom of the sleeve 101 leaving both sides open 105 in order to slide onto luggage belt or other strapping. The embodied sleeve 101 is not limited to stitching and strong snaps, rivets, hook and loop (Velcro) and other fastening devices may be used. The preferred sleeves 101 are manufactured to accommodate the size of a common luggage strap and other strapping devices. FIG. 3 is a diagram showing the side 105 of the sleeve 101 as it would be stretched to slide over the luggage belt or other strapping. In FIG. 2 the attachment stitching 111 is shown in white for illustration purposes, but stitching 111 may also match the sleeve 101 color. The collectible sleeve 101 may be made from an elasticized fabric, stitched 111 on each end, leaving the sides open 105 so that is can be slid over the end of a belt including but not limited to luggage, backpack, laptop bag, briefcase, and the like.

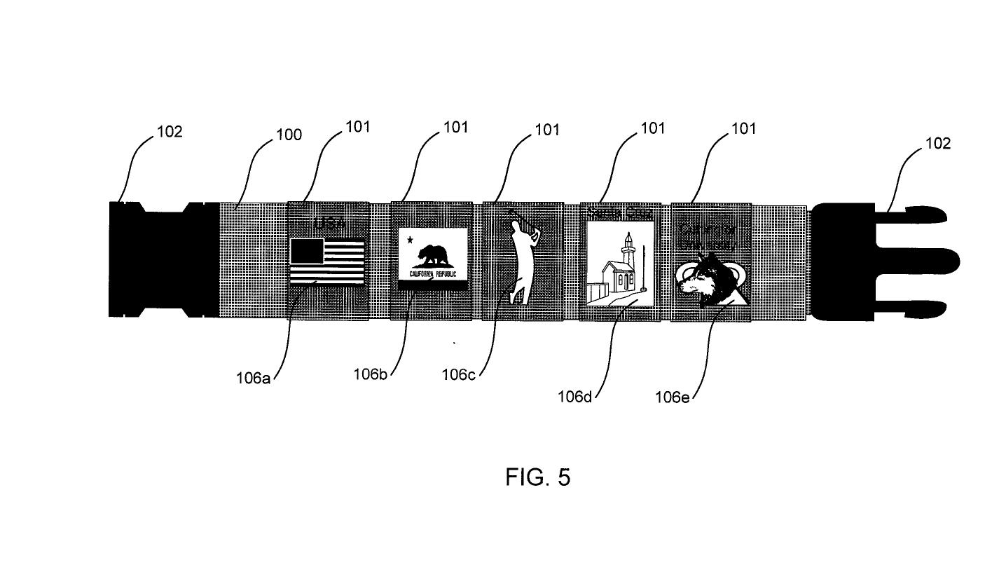

FIGS. 4 and 5 show a small sample of the variety of information that could be created on the embodied sleeves 101. FIG. 4 is a diagram showing the front of five sample identifiers 106a, 106b, 106c, 106d, and 106e on the sleeves 101. The sleeves 101 are preferably made from an elasticized fabric sewed into a flattened tube with stitching or patch applique on the front side 103. The sleeves 101 are almost limitless in the variety of designs 106 available for the traveler to choose sleeves 101 representing their individual preferences. The exemplary sleeves displayed include a US Flag 106a, a California Flag 106b, a sports symbol in the form of a golfer 106c, a city symbol and identification in the form of a Santa Cruz logo 106d, and the logo of a University in the form of the Cuttington University logo 106e. FIG. 5 is a diagram showing a luggage belt 100 with the five sample sleeves 101, 106a-106e on it. The luggage belt 100 is fastened to the luggage 100 with a fastening attachment 102.

Exemplary Uses:

Sleeve Collections: it is contemplated in the present invention that the individual sleeves may be great collectible items. An individual may choose to collect sleeves with favorite shops, destinations, TV shows, sports teams, Film, TV or literary characters and the like. Much like the pin trading one sees for the Olympic games or Disney pins, the identification sleeves could provide the same degree of collectability.

Personal Identification: it is contemplated in the present invention that the individual sleeves, when attached to a personal item via a strap or belt, enable a user to more rapidly and accurately identify their personal items comprising the sleeves. The user may customize their luggage in very diverse ways by including colors, numbers, lettering, monograms, or any variety of collectible sleeves, presented above. Additionally, for those with multiple bags, embodied sleeves may more accurately allow the user to account for all bags. For example, the sleeves attached may provide information that one bag retrieved is bag “one of three” and the next bag is “three of three”. This enables the user to make sure all bags are accounted for before leaving the luggage carousel. Another embodied sleeve system may include information as to which bag has their medicine based on a medical symbol sleeve, or which bag has their business suit or presentation and various external coding sleeves to enable the user travelling with large amounts of luggage to more rapidly access their property.

Group Identification: it is contemplated in the present invention that the individual sleeve systems could be utilized by groups such as teams or tours to more accurately identify and account for a large volume of personal items. In this case, a specified sleeve system could be unique to the group with any of the combinations of colored sleeves, or personalized sleeves previously mentioned. Additionally, a sleeve identification could be used for each member of the group. And further, an additional sleeve identification system could provide an accounting of the groups luggage, by having each bag labeled as 1 of 25 through 25 of 25 for example. This system could help insure that the Tour providers grab all of the personal items for the group or team, and if a bag is missing they can more quickly identify which bag and/or whose bag is missing e.g., bag 7 of 25.

Although the invention has been described with reference to the above examples, it will be understood that modifications and variations are encompassed within the spirit and scope of the invention. Accordingly, the invention is limited only by the following claims.

What is claimed is:

1. A device for more rapidly and accurately identifying a personal item comprising:
a personal item;
a belt or strap attached to said personal item; and
at least one personal identification sleeve attached to said belt or strap; wherein said sleeve provides an owner with information that the personal item is theirs by conveying specific and easily viewable information to the owner.

2. The device of claim 1 further comprising matching identifiers to group separate pieces of luggage to a group or individual.

3. The device of claim 2 wherein the personal identification sleeves provides an information about the total number of bags associated with the individual or group.
